(19) United States
(12) Patent Application Publication
(10) Pub. No.: US 2023/0323768 A1
(43) Pub. Date: Oct. 12, 2023

(54) AUTOMATED HYDROCARBON TRANSPORT PIPELINE FAILURE CATEGORIZATION USING IMAGE RECOGNITION

(71) Applicant: Saudi Arabian Oil Company, Dhahran (SA)

(72) Inventors: Arij Ibrahim Ruwaii, Dhahran (SA); Bashaer Abdullah Alhammad, Jubail (SA); Christian Canto Maya, Dhahran (SA)

(21) Appl. No.: 17/658,775

(22) Filed: Apr. 11, 2022

(51) Int. Cl. E21B 47/117; E21B 47/002

(52) U.S. Cl. CPC E21B 47/117; E21B 47/002; E21B 2200/22

(57) ABSTRACT

The present disclosure provides computer-implemented methods, media, and systems for automated hydrocarbon transport pipeline failure categorization using image recognition. One example method includes storing multiple pipeline images into an image library, where each pipeline image includes an image of a segment of one of multiple hydrocarbon transport pipelines, the image including one or more patterns of a failure associated with the segment, the failure is associated with one of multiple pipeline failure modes. A convolutional neural network (CNN) is trained using the image library to categorize the multiple pipeline failure modes. An image of a pipeline is received, the pipeline includes a segment with a pipeline failure. The pipeline failure is categorized according to the multiple pipeline failure modes, by processing the image of the pipeline using the CNN. The categorized pipeline failure is provided for generation of a preliminary failure analysis report of the pipeline.

### TECHNICAL FIELD

The present disclosure relates to computer-implemented methods, media, and systems for automated hydrocarbon transport pipeline failure categorization using image recognition.

### BACKGROUND

Pipelines are generally safe and effective method for transportation of hydrocarbons such as gas and liquids across long distances. Nevertheless, failures in hydrocarbon transport pipelines can happen for various reasons. For example, some failures of transport pipelines can be categorized based on the type of corrosion. Corrosion types can be associated with unique patterns of pipeline failures.

Subject matter experts (SMEs) can assess the pipeline failures in order to categorize them, and generate pipeline failure reports based on the categorized pipeline failures. The pipeline failure reports can support decision making with regard to the reliability and repair of pipeline assets. The lack of pipeline failure reports can mislead decision analysis aimed at improving the operation sustainability. Sometimes pipeline failure analysis is neglected in the field or the cause of pipeline failure is dismissed as a generic failure cause, due to the lack of SMEs with expertise in assessing the pipeline failures.

### SUMMARY

The present disclosure involves computer-implemented methods, media, and systems for automated hydrocarbon transport pipeline failure categorization using image recognition. One example method includes storing multiple pipeline images into an image library, where the multiple pipeline images are associated with multiple hydrocarbon transport pipelines, each pipeline image includes an image of a segment of one of the multiple hydrocarbon transport pipelines, the image including one or more patterns of a failure associated with the segment of one of the multiple hydrocarbon transport pipelines, the failure is associated with a pipeline failure mode included in multiple pipeline failure modes, and the multiple pipeline failure modes are associated with failures in the multiple pipeline images. A convolutional neural network (CNN) is trained using the multiple pipeline images in the image library to categorize the multiple pipeline failure modes. An image of a pipeline through which hydrocarbons are being transported is received, where the image of the pipeline is not included in the multiple pipeline images, the pipeline includes a segment with a pipeline failure, and the image of the pipeline includes one or more patterns of the pipeline failure. The image of the pipeline is provided as an input to the CNN. The pipeline failure is categorized according to the multiple pipeline failure modes, by processing the image of the pipeline using the CNN and based on training the CNN to categorize the multiple pipeline failure modes. The categorized pipeline failure is provided for generation of a preliminary failure analysis report of the pipeline.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates example images of hydrocarbon transport pipelines with failures of different types, in accordance with example implementations of this disclosure.

FIG. 2 is a schematic illustration of an example process for automated hydrocarbon transport pipeline failure categorization using image recognition, in accordance with example implementations of this disclosure.

FIG. 3 illustrates an example architecture of a convolutional neural network (CNN), in accordance with example implementations of this disclosure.

FIG. 4 is a flowchart illustrating an example method for automated hydrocarbon transport pipeline failure categorization using image recognition, in accordance with example implementations of this disclosure.

FIG. 5 is a schematic illustration of example computer systems that can be used to execute implementations of the present disclosure.

### DETAILED DESCRIPTION

To provide a preliminary pipeline failure analysis without involving the SMEs from the beginning of categorizing pipeline failures, image recognition techniques can be implemented to automatically identify pipeline failures based on ever-growing image library of pipeline failures previously recognized by SMEs. The image library of pipeline failures establishes a centralized data collection of pipeline failures, which provides a data collection for analyzing individual pipelines and the factors that are associated with their failures. Automated pipeline failure categorization can reduce the likelihood of a repeated incident and therefore improve safety and productivity and reduce the risk of unplanned outages.

This disclosure describes technologies for automated hydrocarbon transport pipeline failure categorization using image recognition. In some implementations, a failure detection method that uses machine learning can be applied in the pipeline failure analysis process. When a failure occurs, the failure can be captured in an image and then the image is analyzed by machine learning based on a Convolutional Neural Network (CNN), in order to categorize the pipeline failure. This pipeline failure categorization method can analyze failures in real time and generate preliminary pipeline failure reports that include the failure categorization and the probability of correctly categorizing the pipeline failure. The categorized failure can be reviewed by SMEs to determine if the pipeline failure is categorized correctly by the CNN based machine learning. If the SMEs determine that the pipeline failure is categorized correctly by the CNN based machine learning model, the image of the pipeline failure and the categorized failure can be added to the image library to improve the performance of the CNN based machine learning.

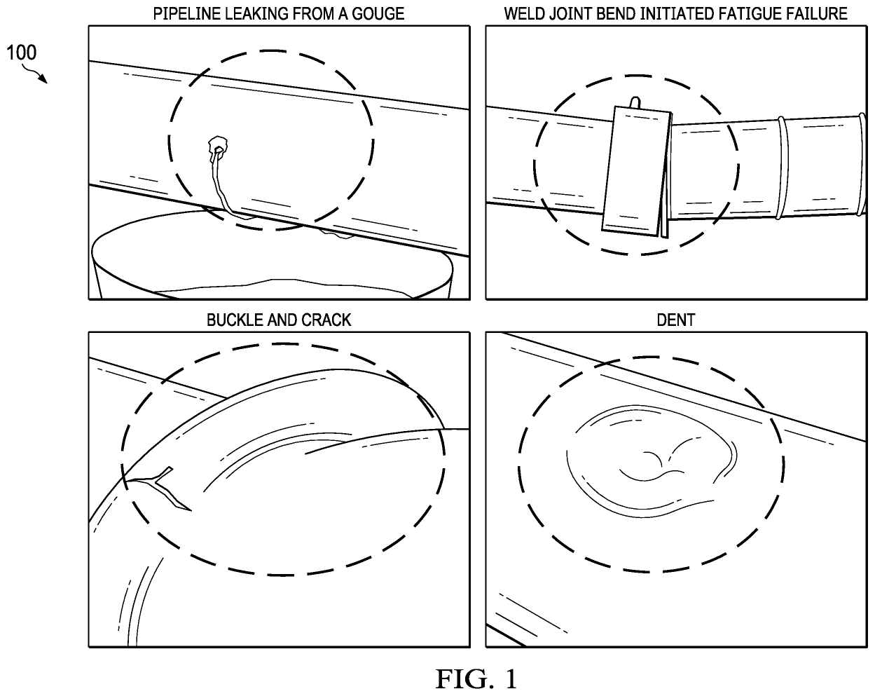

FIG. 1 illustrates example images of hydrocarbon transport pipelines with failures of different types, in accordance with example implementations of this disclosure. Example hydrocarbon transport pipeline failures shown in these example images include pipeline leaking from a gouge, weld joint bend initiated fatigue failure, buckle and crack, and dent.

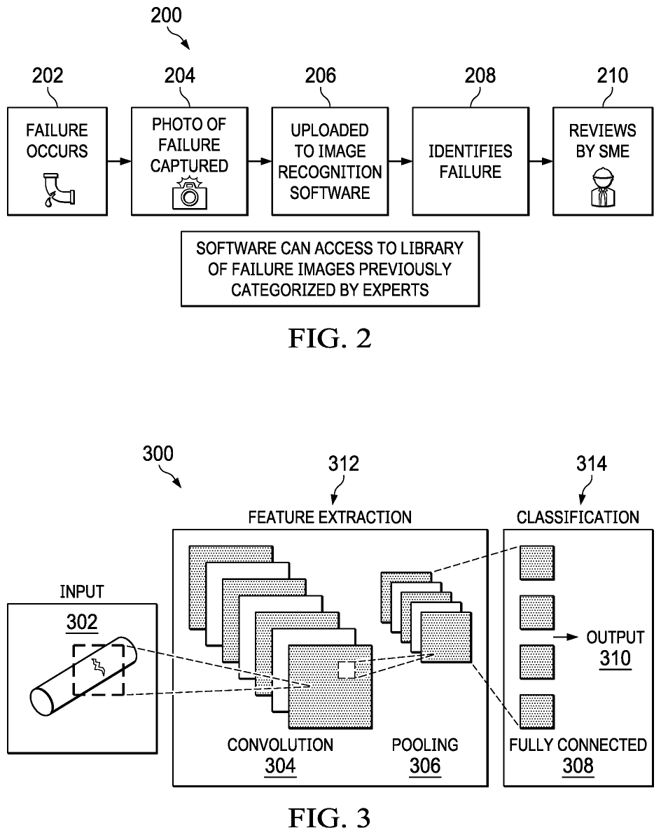

FIG. 2 is a schematic illustration of an example process 200 for automated hydrocarbon transport pipeline failure categorization using image recognition, in accordance with example implementations of this disclosure.

At 202, a failure in a pipeline for transporting hydrocarbons occurs. Example causes of the failure can be categorized as mechanical damage, environmental causes such as corrosion and hydrogen cracking, pipeline fatigue, or other miscellaneous causes.

At 204, a photo of the failure is captured. In some implementations, an inspection operator can capture the photo of the failure using a camera, when preparing an inspection report of the pipeline.

At 206, the captured photo of pipeline failure is uploaded to an image recognition software for categorization of the pipeline failure. In some implementations, the image recognition software can be a web based system that integrates a convolutional neural network (CNN) based machine learning model with a user interface, where a user provides the captured photo of the failure and historical operating conditions for the failed pipeline as input to the user interface. The historical operating conditions can include, for example, the length of the pipeline, the number of leaks happened before, type of corrosion, and scale thickness. The CNN based machine learning model can have access to a library of pipeline failure images with corresponding failures previously categorized by SMEs.

At 208, the CNN based machine learning model identifies the pipeline failure using the library of pipeline failure images with corresponding failures previously categorized by the SMEs.

At 210, the categorized pipeline failure is reviewed by a subject matter expert (SME) to determine if the pipeline failure is categorized correctly by the CNN based machine learning model. If the SME determines that the pipeline failure is categorized correctly by the CNN based machine learning model, the photo of the failure and the categorized failure can be added to the library to improve the performance of the CNN based machine learning model.

FIG. 3 illustrates an example architecture 300 of a CNN in a CNN based machine learning model, in accordance with example implementations of this disclosure. In some implementations, image recognition and classification using CNN differ from traditional image recognition and classification algorithms in that CNN can perform image processing operations without the need of traditional algorithm calculations, by automatically extracting features of images using its convolutional filter during model training. CNN places the input data in a representation of multidimensional arrays. Its performance improves when more labeled images are used for the training of the CNN. CNN processes every part of the input image, which is also termed the receptive field. It assigns weights to each neuron based on the importance of the receptive field. Therefore the importance of neurons can be distinguished from each other. Each neuron in CNN represents a function and computes an output value by applying the function to the input values received from the receptive fields in the previous layer.

In some implementations, the CNN architecture 300 consists of three types of layers: a convolution layer, a pooling layer, and a fully connected layer. The CNN has two major functions: the feature extraction function 312 and the classification function 314. The feature extraction function 312 includes the convolution operation 304 and the pooling operation 306, and the classification function 314 includes the fully connected operation 308. The convolution operation 304 is performed by the convolution layer, the pooling operation 306 is performed by the pooling layer, and the fully connected operation 308 is performed by the fully connected layer.

In some implementations, the convolution layer extracts features of a pipeline failure from the input 302. The input 302 to the convolution layer 304 can be an image of a pipeline failure captured at 204 of FIG. 2. The convolution layer can transform the input image 302 using a set of learnable kernels or filters in order to create feature maps associated with the features of the pipeline failure. Each kernel is a set of pixels from the input image 302 and is convolved across the input image 302 to produce a two-dimensional feature map of the kernel. As a result, the CNN learns the kernel parameters when it detects some specific types of features at some spatial locations in the input image 302, for example, lines and edges in the input image 302. Therefore the CNN apply kernels to the input image 302 to create feature maps that summarize the presence of detected features in the input image 302.

In some implementations, the pooling layer extracts more abstract features of the pipeline failure based on the feature maps created by the convolution layer, by performing image reduction that involves reducing the sizes of the feature maps. The image reduction can include the calculation of the average or maximum value of individual subsets of the feature maps. For example, the image reduction can be a down sampling process that divides a feature map into a set of rectangles, and for each rectangle, the pooling layer calculates the maximum value of the pixel within the rectangle and represents the rectangle using the maximum value, thereby resizes the rectangle into a single value.

In some implementations, the fully connected layer produces the final output 310 of the CNN by categorizing the more abstracted features extracted by the pooling layer. It links neighboring neurons together to flatten the output of the pooling layer into a one-dimensional vector. Neurons in the fully connected layer of the CNN have full connectivity with all neurons in the preceding and succeeding layers as in regular fully connected layers in neural networks. The output 310 of the fully connected layer is the categorization of the pipeline failure captured in input image 302.

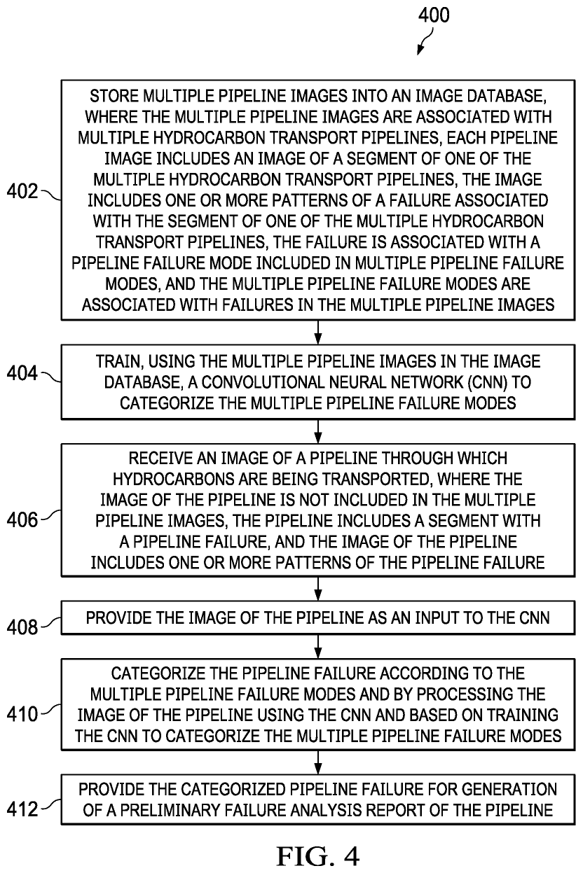

FIG. 4 is a flowchart illustrating an example method 400 for automated hydrocarbon transport pipeline failure categorization using image recognition, in accordance with example implementations of this disclosure.

At 402, a computer system stores multiple pipeline images into an image library, where the multiple pipeline images are associated with multiple hydrocarbon transport pipelines, each pipeline image includes an image of a segment of one of the multiple hydrocarbon transport pipelines, the image includes one or more patterns of a failure associated with the segment of one of the multiple hydrocarbon transport pipelines, the failure is associated with a pipeline failure mode included in multiple pipeline failure modes, and the multiple pipeline failure modes are associated with failures in the multiple pipeline images.

At 404, the computer system trains, using the multiple pipeline images in the image library, a convolutional neural network (CNN) to categorize the multiple pipeline failure modes.

At 406, the computer system receives an image of a pipeline through which hydrocarbons are being transported, where the image of the pipeline is not included in the multiple pipeline images, the pipeline includes a segment with a pipeline failure, and the image of the pipeline includes one or more patterns of the pipeline failure.

At 408, the computer system provides the image of the pipeline as an input to the CNN.

At 410, the computer system categorizes the pipeline failure according to the multiple pipeline failure modes and by processing the image of the pipeline using the CNN and based on training the CNN to categorize the multiple pipeline failure modes.

At 412, the computer system provides the categorized pipeline failure for generation of a preliminary failure analysis report of the pipeline.

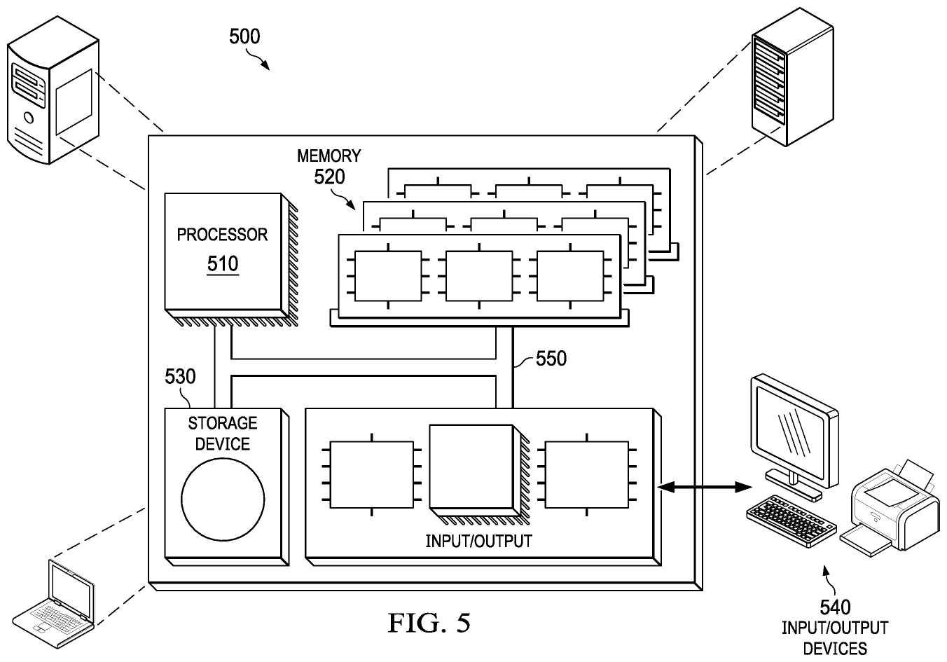

FIG. 5 illustrates a schematic diagram of an example computing system 500. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, and 540 are interconnected using a system bus 550. The processor 510 is capable of processing instructions for execution within the system 500. In some implementations, the processor 510 is a single-threaded processor. The processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. The memory 520 is a volatile memory unit. The memory 520 is a non-volatile memory unit. The storage device 530 is capable of providing mass storage for the system 500. The storage device 530 is a computer-readable medium. The storage device 530 may be a floppy disk device, a hard disk device, an optical disk device, or a tape device. The input/output device 540 provides input/output operations for the system 500. The input/output device 540 includes a keyboard and/or pointing device. The input/output device 540 includes a display unit for displaying graphical user interfaces.

Certain aspects of the subject matter described here can be implemented as a method. Multiple pipeline images are stored into an image library. The multiple pipeline images are associated with multiple hydrocarbon transport pipelines. Each pipeline image includes an image of a segment of one of the multiple hydrocarbon transport pipelines. The image includes one or more patterns of a failure associated with the segment of one of the multiple hydrocarbon transport pipelines. The failure is associated with a pipeline failure mode included in multiple pipeline failure modes, and the multiple pipeline failure modes are associated with failures in the multiple pipeline images. A convolutional neural network (CNN) is trained using the multiple pipeline images in the image library to categorize the multiple pipeline failure modes. An image of a pipeline is received, where hydrocarbons are being transported through the pipeline. The image of the pipeline is not included in the multiple pipeline images. The pipeline includes a segment with a pipeline failure, and the image of the pipeline includes one or more patterns of the pipeline failure. The image of the pipeline is provided as an input to the CNN. The pipeline failure is categorized according to the multiple pipeline failure modes, where the image of the pipeline is processed using the CNN and based on training the CNN to categorize the multiple pipeline failure modes. The categorized pipeline failure is provided for generation of a preliminary failure analysis report of the pipeline.

An aspect taken alone or combinable with any other aspect includes the following features. The CNN includes a convolution layer, a pooling layer, and a fully connected layer.

An aspect taken alone or combinable with any other aspect includes the following features. Processing the image of the pipeline using the CNN includes creating, using the convolution layer, feature maps based on the one or more patterns of the pipeline failure in the image of the pipeline, extracting pipeline failure features from the feature maps by reducing dimensions of the feature maps using the pooling layer, and categorizing the pipeline failure according to the multiple pipeline failure modes by categorizing the extracted pipeline failure features using the fully connected layer.

An aspect taken alone or combinable with any other aspect includes the following features. The multiple pipeline failure modes include at least one of pipeline leakage, pipeline weld joint bend, pipeline buckling, pipeline crack, or pipeline dent.

An aspect taken alone or combinable with any other aspect includes the following features. Categorizing the pipeline failure according to multiple pipeline failure modes includes determining a mode of the pipeline failure, where the mode of the pipeline failure is one of the multiple pipeline failure modes.

An aspect taken alone or combinable with any other aspect includes the following features. Providing the categorized pipeline failure for generation of a preliminary failure analysis report of the pipeline includes generating the preliminary failure analysis report of the pipeline based on the determined mode of the pipeline failure.

An aspect taken alone or combinable with any other aspect includes the following features. The image library is updated, where the image of the pipeline and the categorized pipeline failure are stored into the image library after the categorized pipeline failure is confirmed by a subject matter expert (SME). The CNN is trained based on the updated image library to categorize the multiple pipeline failure modes.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method, comprising:
storing a plurality of pipeline images into an image library, wherein the plurality of pipeline images are associated with a plurality of hydrocarbon transport pipelines, wherein each pipeline image comprises an image of a segment of one of the plurality of hydrocarbon transport pipelines, the image including one or more patterns of a failure associated with the segment of one of the plurality of hydrocarbon transport pipelines, wherein the failure is associated with a pipeline failure mode comprised in a plurality of pipeline failure modes, and wherein the plurality of pipeline failure modes are associated with failures in the plurality of pipeline images;
training, using the plurality of pipeline images in the image library, a convolutional neural network (CNN) to categorize the plurality of pipeline failure modes;
receiving an image of a pipeline through which hydrocarbons are being transported, wherein the image of the pipeline is not included in the plurality of pipeline images, wherein the pipeline comprises a segment with a pipeline failure, and wherein the image of the pipeline comprises one or more patterns of the pipeline failure;
providing the image of the pipeline as an input to the CNN;
categorizing the pipeline failure according to the plurality of pipeline failure modes and by processing the image of the pipeline using the CNN and based on training the CNN to categorize the plurality of pipeline failure modes; and
providing the categorized pipeline failure for generation of a preliminary failure analysis report of the pipeline.

2. The computer-implemented method according to claim 1, wherein the CNN comprises a convolution layer, a pooling layer, and a fully connected layer.

3. The computer-implemented method according to claim 2, wherein the processing the image of the pipeline using the CNN comprises:
creating, using the convolution layer, feature maps based on the one or more patterns of the pipeline failure in the image of the pipeline;
extracting pipeline failure features from the feature maps by reducing sizes of the feature maps using the pooling layer; and
categorizing the pipeline failure according to the plurality of pipeline failure modes by categorizing the extracted pipeline failure features using the fully connected layer.

4. The computer-implemented method according to claim 1, wherein the plurality of pipeline failure modes comprise at least one of mechanical failure, corrosion, hydrogen cracking, or pipeline fatigue.

5. The computer-implemented method according to claim 1, wherein the categorizing the pipeline failure according to a plurality of pipeline failure modes comprises determining a mode of the pipeline failure, wherein the mode of the pipeline failure is one of the plurality of pipeline failure modes.

6. The computer-implemented method according to claim 5, wherein the providing the categorized pipeline failure for generation of a preliminary failure analysis report of the pipeline comprises generating the preliminary failure analysis report of the pipeline based on the determined mode of the pipeline failure.

7. The computer-implemented method according to claim 1, further comprising:
updating the image library by storing the image of the pipeline and the categorized pipeline failure into the image library after the categorized pipeline failure is confirmed by a subject matter expert (SME); and
training the CNN based on the updated image library to categorize the plurality of pipeline failure modes.

8. A non-transitory, computer-readable medium storing one or more instructions executable by a computer system to perform operations comprising:
storing a plurality of pipeline images into an image library, wherein the plurality of pipeline images are associated with a plurality of hydrocarbon transport pipelines, wherein each pipeline image comprises an image of a segment of one of the plurality of hydrocarbon transport pipelines, the image including one or more patterns of a failure associated with the segment of one of the plurality of hydrocarbon transport pipelines, wherein the failure is associated with a pipeline failure mode comprised in a plurality of pipeline failure modes, and wherein the plurality of pipeline failure modes are associated with failures in the plurality of pipeline images;
training, using the plurality of pipeline images in the image library, a convolutional neural network (CNN) to categorize the plurality of pipeline failure modes;
receiving an image of a pipeline through which hydrocarbons are being transported, wherein the image of the pipeline is not included in the plurality of pipeline images, wherein the pipeline comprises a segment with a pipeline failure, and wherein the image of the pipeline comprises one or more patterns of the pipeline failure;
providing the image of the pipeline as an input to the CNN;
categorizing the pipeline failure according to the plurality of pipeline failure modes and by processing the image of the pipeline using the CNN and based on training the CNN to categorize the plurality of pipeline failure modes; and
providing the categorized pipeline failure for generation of a preliminary failure analysis report of the pipeline.

9. The non-transitory, computer-readable medium according to claim 8, wherein the CNN comprises a convolution layer, a pooling layer, and a fully connected layer.

10. The non-transitory, computer-readable medium according to claim 9, wherein the processing the image of the pipeline using the CNN comprises:
creating, using the convolution layer, feature maps based on the one or more patterns of the pipeline failure in the image of the pipeline;
extracting pipeline failure features from the feature maps by reducing sizes of the feature maps using the pooling layer; and
categorizing the pipeline failure according to the plurality of pipeline failure modes by categorizing the extracted pipeline failure features using the fully connected layer.

11. The non-transitory, computer-readable medium according to claim 8, wherein the plurality of pipeline failure modes comprise at least one of mechanical failure, corrosion, hydrogen cracking, or pipeline fatigue.

12. The non-transitory, computer-readable medium according to claim 8, wherein the categorizing the pipeline failure according to a plurality of pipeline failure modes comprises determining a mode of the pipeline failure, wherein the mode of the pipeline failure is one of the plurality of pipeline failure modes.

13. The non-transitory, computer-readable medium according to claim 12, wherein the providing the categorized pipeline failure for generation of a preliminary failure analysis report of the pipeline comprises generating the preliminary failure analysis report of the pipeline based on the determined mode of the pipeline failure.

14. The non-transitory, computer-readable medium according to claim 8, wherein the operations further comprise:
updating the image library by storing the image of the pipeline and the categorized pipeline failure into the image library after the categorized pipeline failure is confirmed by a subject matter expert (SME); and
training the CNN based on the updated image library to categorize the plurality of pipeline failure modes.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
storing a plurality of pipeline images into an image library, wherein the plurality of pipeline images are associated with a plurality of hydrocarbon transport pipelines, wherein each pipeline image comprises an image of a segment of one of the plurality of hydrocarbon transport pipelines, the image including one or more patterns of a failure associated with the segment of one of the plurality of hydrocarbon transport pipelines, wherein the failure is associated with a pipeline failure mode comprised in a plurality of pipeline failure modes, and wherein the plurality of pipeline failure modes are associated with failures in the plurality of pipeline images;
training, using the plurality of pipeline images in the image library, a convolutional neural network (CNN) to categorize the plurality of pipeline failure modes;
receiving an image of a pipeline through which hydrocarbons are being transported, wherein the image of the pipeline is not included in the plurality of pipeline images, wherein the pipeline comprises a segment with a pipeline failure, and wherein the image of the pipeline comprises one or more patterns of the pipeline failure;
providing the image of the pipeline as an input to the CNN;
categorizing the pipeline failure according to the plurality of pipeline failure modes and by processing the image of the pipeline using the CNN and based on training the CNN to categorize the plurality of pipeline failure modes; and
providing the categorized pipeline failure for generation of a preliminary failure analysis report of the pipeline.

16. The computer-implemented system according to claim 15, wherein the CNN comprises a convolution layer, a pooling layer, and a fully connected layer.

17. The computer-implemented system according to claim 16, wherein the processing the image of the pipeline using the CNN comprises:
creating, using the convolution layer, feature maps based on the one or more patterns of the pipeline failure in the image of the pipeline;
extracting pipeline failure features from the feature maps by reducing sizes of the feature maps using the pooling layer; and
categorizing the pipeline failure according to the plurality of pipeline failure modes by categorizing the extracted pipeline failure features using the fully connected layer.

18. The computer-implemented system according to claim 15, wherein the plurality of pipeline failure modes comprise at least one of mechanical failure, corrosion, hydrogen cracking, or pipeline fatigue.

19. The computer-implemented system according to claim 15, wherein the categorizing the pipeline failure according to a plurality of pipeline failure modes comprises determining a mode of the pipeline failure, wherein the mode of the pipeline failure is one of the plurality of pipeline failure modes.

20. The computer-implemented system according to claim 19, wherein the providing the categorized pipeline failure for generation of a preliminary failure analysis report of the pipeline comprises generating the preliminary failure analysis report of the pipeline based on the determined mode of the pipeline failure.
